(19) United States
(12) Patent Application Publication
(10) Pub. No.: US 2007/0197710 A1
(43) Pub. Date: Aug. 23, 2007

(54) Polymer Articles With Treated Fillers And Products And Methods Of Using Same

(76) Inventors: Wen Pao Wu, Pittsford, NY (US); David V. Dobreski, Canandaigua, NY (US)

Correspondence Address: BAKER BOTTS L.L.P., 30 ROCKEFELLER PLAZA, 44th Floor, NEW YORK, NY, 10112-4498, US

(21) Appl. No.: 11/687,502

(22) Filed: Mar. 16, 2007

Related U.S. Application Data
(63) Continuation of application No. PCT/US05/33001, filed on Sep. 16, 2005.
(60) Provisional application No. 60/611,263, filed on Sep. 17, 2004.

(51) Int. Cl. C08K 9/04

(52) U.S. Cl. 524/445; 523/216; 428/327

(57) ABSTRACT

The present invention provides for a polymer composite article with a treated filler and methods for making the same. The polymer composite article includes a polymer capable of being formed into a product shape and a treated filler which is dispersed throughout the polymer forming the composite article. The filler is treated by techniques which exfoliate, delaminate or intercalate the filler particles into individual micro and/or nano size particulates and platelets. Ideally, the treated filler has a median particle size ranging from about 0.1 nm-10 μm. The treated filler enhances the rigidity, barrier properties, heat deflection temperature, clarity, nucleation characteristics, fire retardant characteristics and impact properties of the article. In a preferred embodiment, the article is a polymer composite sheet. The products formed from the polymer composite article include containers, cups, bags, sleeves, bottles, cups, plates, bowls, storageware, dinnerware and cookware. The present invention also provides for methods of fabricating the polymer composite articles.

### BACKGROUND OF THE INVENTION

1. Field of the Invention

The present invention relates to a polymer material with treated fillers and articles and methods of using same. Particularly, the present invention is directed to the use of treated filler materials in the manufacture of polymer composite articles, such as polymer composite sheets, to be formed or molded into packaging or consumer products having enhanced properties.

2. Description of Related Art

Packaging structures such as boxes, containers, trays, dinnerware and the like, are formed from a variety of thermoplastic and thermosetting polymers. Mineral fillers are used extensively to enhance the performance of a wide range of such polymers. It is well known that the improvement in the properties of polymers can occur with the proper use of well-dispersed fillers possessing high aspect ratios and small particle sizes. Physical properties of the polymer that can be improved by the use of such fillers include stiffness, strength, temperature resistance, dimensional stability, surface hardness and scratch resistance. Other properties that can be improved with the use of well-dispersed fillers possessing high aspect ratios and small particle sizes include clarity, chemical resistance, flame retardancy, Theological properties, and crystallinity. Such fillers can also be used to reduce permeability to gases and liquids, thereby improving the barrier property of the polymer.

The most commonly used fillers in plastics are calcium carbonate, wollastonite, silica and the phyllosilicates such as kaolin, talc and mica. Many fillers, such as calcium carbonate, silica and phyllosilicates, however, are hydrophilic and therefore must be surface treated in order to improve their dispersion and interaction with the polymer matrix.

Conventional surface treatment of fillers includes reacting the filler surfaces with organosilanes, modified oligomers and polymers containing anhydride functional groups and a wide variety of surfactants. More recently, it has been determined that the exfoliation and nanoscale dispersion of small amounts of treated fillers into polymers results in composite materials with enhanced physical features and significant reductions in weight as compared to polymers with conventional or non-treated fillers. Nanocomposites are a new class of composites that are particle-filled polymers for which at least one dimension of the dispersed filler is in the nanometer range (10⁻⁹ meter).

Various methods are known in the art for creating composites with modified fillers which are exfoliated and dispersed in a polymer matrix. Under current methods known in the art, large quantities of volatile polar surfactants are required to ensure complete exfoliation, intercalation or delamination of fillers. There thus remains a need for enhancing the properties of composite sheets through the use of treated fillers, particularly, fillers that do not require large quantities of surfactants.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof.

To achieve these and other advantages and in accordance with the purpose of the invention, as embodied and broadly described, the invention is directed to the use of treated fillers in the manufacture of polymer composite articles (e.g., sheets) through conventional processing techniques. Such techniques include, but are not limited to, melt-processing techniques, such as, for example, extrusion, compression molding, blow molding, injection molding, injection blow molding and the like. In accordance with one aspect of the invention, the article is a polymer sheet. The composite sheets are then formed or molded into packaging or consumer products having enhanced physical properties. The products include, but are not limited to, trays, containers, bags, sleeves, bottles, cups, plates, bowls, storageware, dinnerware and cookware. In one aspect of the invention, the composite sheets define at least a portion of the product. The products may also be formed directly from the polymer composite resin.

In accordance with the invention, the polymer composite article includes a polymer capable of being formed into a shape and a treated filler having a median particle size of about 0.1 nm-10 μm, wherein the treated filler is dispersed throughout the polymer.

In further accordance with the invention, the filler is treated by a process which delaminates, intercalates or exfoliates the filler. In accordance with a preferred embodiment of the invention, the filler is treated by an edge-modifying process, which preferably includes a surfactant absorbed along the edges of the filler. Generally the treated fillers include, but are not limited to, calcium carbonate, wollastonite, silica and phyllosilicates.

In accordance with the invention, the treated filler enhances at least one physical property of the polymer article including, rigidity, barrier property, heat deflection temperature, clarity, nucleation, fire retardancy and impact property.

In a further embodiment, the invention is directed to a multi-layer polymer composite article. Preferably, the multi-layered composite article has at least one layer including a polymer and a treated filler.

In yet a further embodiment, the invention includes a polymer composite article including a polymer capable of being formed into a shape, a treated filler having a median particle size of about 0.1 nm-10 μm, and a non-treated filler, wherein both the treated and non-treated fillers are dispersed throughout the polymer matrix.

In yet a further embodiment, the invention includes a method for fabricating a polymer composite article by treating a filler by a process which delaminates, exfoliates or intercalates the filler, dispersing the treated filler into a polymer matrix and forming the polymer matrix into a polymer composite article. In accordance with one aspect of the invention, the fabricated article is a polymer composite sheet.

It is to be understood that both the foregoing general description and the following detailed description are exemplary and are intended to provide further explanation of the invention claimed.

### DETAILED DESCRIPTION OF THE PREFERRED EMBODIMENT

The present invention provides for a polymer composite article with a treated filler for forming packaging and/or consumer products, and methods for making the same. Such polymer composite articles generally include, but are not limited to, sheets, boards, films, foams and finished products that are manufactured using conventional melt-processing techniques such as, for example, extrusion, compression molding, blow molding, injection molding or injection blow molding and the like.

As embodied herein, and in accordance with one aspect of the invention, the invention provides for a polymer composite article including a treated filler and polymer, wherein the treated filler is dispersed throughout the polymer forming the article. Improvement in the properties of polymers is facilitated by the use of well-dispersed fillers possessing high aspect ratios and small particle sizes. The aspect ratio is defined as the ratio of a particle's major axis (e.g., length) to a minor axis (e.g., thickness), or alternatively, a particle's length to its diameter. In accordance with a preferred embodiment of the invention the aspect ratios of the fillers range from 5 to 500 and more preferably between 5 and 100.

Without being bound by a particular theory, it is desirable to enhance the delamination, intercalation or exfoliation of the filler particles into individual platelets or smaller particulates in order to maximize the properties of the resultant polymer composite articles and ultimately the products manufactured therefrom. In accordance with a preferred embodiment of the invention, the fillers are delaminated such that the average platelet or median particle size ranges from about 0.1 nm to 10 μm.

There are many methods to produce treated fillers of nano and micro size particles for use in specific polymeric articles. Generally, the methods can be grouped into three generic categories: (1) in situ polymerization; (2) solution intercalation; and (3) melt exfoliation. Such techniques are disclosed in U.S. Pat. No. 5,876,812, which is incorporated in its entirety by reference herein. Depending on the type of filler used, once treated, the fillers are segregated or separated into platelets or particulates. Any suitable process or technique which successfully reduces the particles of a filler into individual micro and/or nano size platelets or particulates may be used in the present invention. In accordance with a preferred embodiment of the invention, the fillers are treated by techniques which exfoliate, delaminate or intercalate the fillers as described further below. However, it shall be understood that any technique, conventional or non-conventional, which can reduce the particles of a filler into micro and/or nano size particulates or platelets may be used without departing from the spirit or scope of the invention.

Generally, it is desirable to treat the fillers, e.g. the clays or talcs, to facilitate separation of the agglomerates of platelet particles to individual particles and small tactoids. Typically, the fillers are treated by surfactants or swelling agents to modify the surface of the fillers and allow exfoliation, delamination and intercalation of the fillers into the polymer matrix. The polymer chains thus can be intercalated between the layers of the filler or the filler layers may be delaminated and dispersed in a continuous polymer matrix.

Intercalation generally is defined as the insertion of mobile guest species (atoms, molecules or ions) into a crystalline host lattice that contains an interconnected system of empty lattice sites of appropriate size. The intercalation process results in the development of intercalates which are more organophilic and which can be more readily exfoliated (dispersed) when mixed with a polymer to form an ionomeric nanocomposite. These intercalates are typically on the order of 1 nanometer thick, but about 100 to 1,000 nanometers across. This high aspect ratio, and the resulting high surface area, provides high reinforcement efficiency at low loading levels. Intercalation also can be accomplished by dispersing the nanostructured materials in a solution containing an oxidizing agent, e.g., a mixture of nitric acid and sulfuric acid.

In accordance with one embodiment of the invention, the treated filler is integrated into the polymer material matrix by intercalating the surfactant-mineral filler complex with the polymer material matrix to form an intercalated polymer material. In this specific example, the intercalated polymer material has a defined x-ray diffraction profile for an interlayer or gallery spacing. In an alternative embodiment, the integration of the treated filler into the polymer material matrix is accomplished by exfoliating the filler mineral into the polymer material matrix to form a polymer exfoliated filler material.

Several techniques are disclosed for the exfoliation, intercalation or delamination of filler particles. For example, U.S. Pat. No. 6,057,035, which is incorporated in its entirety by reference herein, discloses nanocomposites systems that are exfoliated with tetraphenyl phosphonium to achieve greater temperature stability.

U.S. Pat. No. 5,910,523, which is incorporated in its entirety by reference herein, discloses a composition including a semi-crystalline polyolefin, a clay filler having dispersible platelets in stacks, an amino-functional silane reacted with the filler, and a carboxylated or maleated semi-crystalline polyolefin that has been reacted with the amino-functional silane after the silane was reacted with the filler.

U.S. Pat. No. 6,228,903, which is incorporated in its entirety by reference herein, discloses a composition made by contacting a phyllosilicate material that is exfoliated in an organic solvent with a polymer/carrier composition that includes a water-insoluble polymer and a solvent, whereupon the adherent solvent is driven off.

U.S. Pat. No. 6,451,897, which is incorporated in its entirety by reference herein, discloses a composite material made in a substantially non-oxidizing environment by graft polymerizing a liquid monomer onto a propylene resin in the presence of smectite clay and a free radical initiator. The propylene resin is a porous material, wherein more than 40% of the pores have a diameter greater than 1 micron. The liquid monomer may be a vinyl-substituted aromatic, a vinyl ester, or an unsaturated aliphatic nitrite or carboxylic acid.

U.S. Pat. No. 6,462,122, which is incorporated in its entirety by reference herein, discloses a nanocomposite blend containing a layered silicate material, a matrix polyolefin, and a functionalized polyolefin (e.g., maleic-anhydride-modified polypropylene) that may be blended together in, for example, a twin-screw extruder.

U.S. Pat. No. 4,810,734, which is incorporated in its entirety by reference herein, discloses a process for producing a composite material by contacting a layered clay mineral with a swelling agent in the presence of a dispersion medium such as water, an alkanol, or dimethyl sulfoxide, mixing with a polymerizable monomer or a mixture of monomer and dispersion medium, and polymerizing the monomer in the mixture. Catalysts and accelerators for polymerization can also be present. The polymer that is formed can be, for example, a polyamide, a vinyl polymer, or a thermoset resin.

U.S. Pat. No. 5,514,734, which is incorporated in its entirety by reference herein, discloses a composite material including a polymer matrix having layered or fibrillar particles, e.g., phyllosilicates, uniformly dispersed therein, the particles being bonded to organosilanes, organo titanates, or organo zirconates and having one or more moieties bonded to at least one polymer in the polymer matrix.

U.S. Pat. No. 5,760,121, which is incorporated in its entirety by reference herein, discloses a composite material including a host material such as a polyamide, polyvinylamine, polyethylene terephthalate, polyolefin, or polyacrylate, and exfoliated platelets of a phyllosilicate material. The platelets are derived from an intercalate formed without an onium ion or silane coupling agent by contacting with an intercalant polymer-containing composition containing water and/or an organic solvent.

U.S. Pat. No. 5,910,523, which is incorporated in its entirety by reference herein, discloses a composition comprising (a) a semi-crystalline polyolefin, (b) a clay filler having dispersible platelets in stacks, (c) an amino-functional silane reacted with the filler, and (d) a carboxylated or maleated semi-crystalline polyolefin that has been reacted with the aminofunctional silane after the silane was reacted with the filler.

In accordance with another aspect of the invention, surface treatment of the fillers, in particular those which are hydrophilic, includes reaction of the filler surface with organosilanes, modified oligomers and a wide variety of surfactants. The hydrophilic fillers generally must be surface treated to render them compatible with plasticizing polymers. The surfactant is a swelling agent which assists in the integration of the filler with the polymer material. Typically, the entire surface of the filler is treated with surfactant. However, in a preferred embodiment of the invention, the edges of the fillers are modified using various surfactants, such as, for example organophosphorus and organosulfur compounds. The fillers, such as phyllosilicates, are edge modified with various organic surfactants that preferentially are absorbed along the edges of the fillers. Edge-treatment improves the properties of the resulting polymer composite because less surfactant can be used in the process. U.S. Patent Application 2003/0176537 (now issued as U.S. Pat. No. 6,790,896), which is incorporated in its entirety be reference herein, discloses an edge-treatment of phyllosilicates that uses a fraction of the amount of surfactant used by conventional exfoliation processes. The process can be applied to either an ion exchangeable phyllosilicate, such as a smectite clay or mica, or a non-ion exchangeable phyllosilicate.

Organic molecules suitable as surfactants or swelling agents include cationic surfactants such as ammonium, phosphonium or sulfonium salts; amphoteric surface active agents; derivatives of aliphatic, aromatic or arylaliphatic amines, phosphines and sulfides; and organosilane compounds. Other suitable swelling agents include protonated amino acids and salts thereof containing 2-30 carbon atoms such as 12-aminododecanoic acid, epsilon-caprolactam and like materials. A preferred swelling agent includes ammonium to effect partial or complete cation exchange.

The fillers used in the present invention include, but are not limited to, calcium carbonate, wollastonite, silica and the phyllosilicates such as kaolin, talc and mica. Suitable phyllosilicates for use in the invention are clays, including mica, kaolinite, and smectite, vermiculite, and halloysite clays, and naturally occurring hydrophobic minerals, such as talc. Natural or synthetic phyllosilicates, for example, are sheet structures basically composed of silica tetrahedral layers and alumina octahedral layers. Suitable smectite clays include montmorillonite, hectorite, saponite, sauconite, beidellite, nontronite and synthetic smectites such as Laponite™. Suitable phyllosilicates are available from various companies including Nanocor, Inc., Southern Clay Products, Kunimine Industries, Ltd., Rheox and Argonne National Labs. The phyllosilicates discussed herein have basal surfaces and are arranged in layers of particles stacked on top of one another. The stacking of the clay particles provides interlayers, or galleries, between the phyllosilicate layers. These galleries are normally occupied by cations, typically comprising sodium, potassium, calcium, magnesium ions and combinations thereof, that balance the charge deficiency generated by the isomorphous substitution within the clay layers. Typically, water is also present in the galleries and tends to associate with the cations.

The most preferred fillers in the polymer composite of the present invention are those based on clays and talc. It is known that these layered phyllosilicates can be treated with organic molecules such as, e.g., organic ammonium ions to insert the organic molecules between adjacent planar silicate layers thereby increasing the interlayer spacing between the adjacent silicate layers. This process is known as intercalation and the resulting treated filler is generally referred to as a treated phyllosilicate. The thus-treated intercalated phyllosilicates have interlayer spacing of at least about 10-20 Angstroms and up to about 100 Angstroms. In order to achieve good intercalation, exfoliation and dispersion of the clay minerals, processing conditions should be such that both shear rate and residence time are optimized. Generally, the layered clay material useful in this invention are an agglomeration of individual platelet particles that are closely stacked together like cards, in domains called tactoids. The individual platelet particles of the clays preferably have thickness of about 10 to about 3000 nm. The composites are typically obtained by the intercalation or penetration of the polymer (or a monomer subsequently polymerized) inside galleries of layered phyllosilicates and the subsequent exfoliation, or dispersion, of the intercalate throughout the polymer matrix.

Depending on the type of filler used and the degree of intercalation, exfoliation or delamination obtained, and the particle sizes, the treated filler can be present in any amount suitable to impart enhanced properties to the polymer composite product and articles manufactured therefrom. In a preferred embodiment of the invention, the treated filler is present from about 0.1 to 30 weight percent in the polymer product, more preferably from about 3 to 20 weight percent. However, in accordance with yet another embodiment, the treated filler is present in very small amounts, such as, for example from about 300-1000 parts per million. It shall be understood that any suitable amount of treated filler capable of accomplishing a desired result may be used without departing from the spirit or scope of the invention.

In accordance with an exemplary embodiment of the invention, the preferred fillers are phyllosilicates such as talcs or clays which have been treated via edge-modifying techniques. In a preferred embodiment, the phyllosilicates are edge-modified using various organophosphorus and/or organosulfur compounds.

In accordance with a preferred embodiment of the invention, in order to obtain polymer composite articles with enhanced properties, the treated fillers should be exfoliated, intercalated or delaminated so as to be dispersed in the form of individual platelets or aggregates having sizes of about 0.1 nm-10 μm.

The polymeric component of the composite includes, but is not limited to, functionalized or non-functionalized propylene polymers, functionalized or non-functionalized ethylene polymers, functionalized or non-functionalized styrenic block copolymers, styrene butadiene copolymers, ethylene ionomers, styrenic block ionomers, polyurethanes, polyesters, polycarbonate, polystyrene, and mixtures or copolymers thereof.

Additional polymers suitable for use in the composites of the present invention are exemplified, but not limited to, polyolefins such as low density polyethylene (LDPE), linear low density polyethylene (LLDPE), medium density polyethylene (MDPE), high density polyethylene (HDPE), and polypropylene (PP), polyamides such as poly(m-xyleneadipamide) (MXD6), poly(hexamethylenesebacamide), poly(hexamethyleneadipamide) and poly(epsilon-caprolactam), polyacrylonitriles, polyesters such as poly(ethylene terephthalate), polylactic acid (PLA), polycaprolactone (PCL) and other aliphatic or aromatic compostable or degradable polyesters, alkenyl aromatic polymers such as polystyrene, and mixtures or copolymers thereof. Other polymers suitable for use in the composites of the invention include ethylene vinyl alcohol copolymers, ethylene vinyl acetate copolymers, polyesters grafted with maleic anhydride, polyvinylidene chloride (PVdC), aliphatic polyketone, LCP (liquid crystalline polymers), ethylene methyl acrylate copolymer, ethylene-norbornene copolymers, polymethylpentene, ethylene acrylic acid copoloymer, and mixtures or copolymers thereof. Further polymers that may be used include epoxy and polyurethane adhesives.

Although not required, the oligomers and/or polymers of the present invention may also include suitable additives normally used in polymers. Such additives may be employed in conventional amounts and may be added directly to the reaction forming the functionalized polymer or oligomer or to the matrix polymer. Illustrative of such additives known in the art include, but are not limited to, colorants, pigments, carbon black, glass fibers, fillers, impact modifiers, antioxidants, stabilizers, flame retardants, reheat aids, crystallization aids, acetaldehyde reducing compounds, recycling release aids, oxygen scavengers, plasticizers, nucleators, mold release agents, compatibilizers, and the like, or their combinations.

In accordance with one aspect of the invention, the polymer article preferably has at least one layer including a polymer and a treated filler dispersed throughout the at least one layer to define a polymer article, such as, for example a polymer sheet. In a further embodiment, the at least one layer further includes a non-treated filler dispersed throughout the at least one layer. In further accordance with the invention, the polymer composite article can have a multi-layered construction The multi-layered polymer composite article can include at least one additional layer of polymer material, wherein the at least one additional layer includes a treated filler. In accordance with yet another aspect of the invention, the at least one additional layer includes a non-treated filler. Further in accordance with the invention, the multi-layered polymer composite article includes at least one layer including a polymer and a treated filler and at least one layer including a polymer and a non-treated filler.

For purposes of illustration and not limitation, the polymer article can include a treated filler disposed adjacent to a second layer of the same or different properties or in a preferred embodiment disposed intermediate to two or more layers. Thus, the multi-layer polymer article may also contain one or more layers of the treated filler composite of this invention and one or more layers of a structural polymer. A wide variety of structural polymers may be used. Illustrative of structural polymers are polyesters, polyetheresters, polyamides, polyesteramides, polyurethanes, polyimides, polyetherimides, polyureas, polyamideimides, polyphenyleneoxides, phenoxy resins, epoxy resins, polyolefins, polyacrylates, polystyrene, polyethylene-co-vinyl alcohols (EVOH), and the like or their combinations and blends. In one embodiment, the preferred structural polymers are polyolefins such as polypropylenes and polyethylenes. In another embodiment, the preferred structural polymers are polyesters, such as poly(ethylene terephthalate) and its copolymers. In yet another embodiment, the preferred structural polymers are alkenyl aromatic polymers, such as polystyrene and high impact polystyrene.

The multi-layer polymer composite article can be formed by a variety of processing techniques including, but not limited to, lamination, co-extrusion and co-injection molding. The multi-layer composite article can be composed of a single or multiple structural materials including, but not limited to, sheets, foams, films, paper and the like. In accordance with a preferred embodiment of the invention, the multi-layer polymer composite article is formed into products as described herein. Numerous advantages are provided in a multi-layer structure. For example, a multi-layer structure with outer (skin) layers having higher rigidity than that of the core layer material can impart an I-beam effect to the entire composite structure, resulting in a higher effective rigidity. A multi-layer structure also allows one to put the lower cost or performance material in the core layer to reduce cost.

In accordance with yet another aspect of the invention, the polymer composite article includes a blend of treated fillers, which have been exfoliated, intercalated or delaminated, and non-treated fillers. For example, and not limitation, the polymer composite sheet may include 0.03-15 weight percent of treated fillers and 5-60 weight percent of non-treated fillers. However, it shall be understood that any suitable ratio of treated filler to non-treated filler capable of accomplishing a desired result can be used without departing from the spirit or scope of the invention. In accordance with a preferred embodiment of the invention, the polymer composite article blend is formed into products as described herein.

In accordance with yet another aspect of the invention, the invention is directed to a polymer composite blend of at least two polymers wherein at least one polymer contains a treated filler. The treated filler is typically dispersed throughout the polymer and enhances the properties of the entire polymer blend. Typically, the polymers are compatible, however, the blend may also include incompatible polymers. Incompatible polymers typically include combinations of polymers that are relatively immiscible, that is, form a cloudy solution and/or cloudy dry film or complete phase separation when mixed. Incompatible polymers also include those that have partial compatibility with each other. However, the addition of a polymeric dispersant can act to aid in the compatibility of the mixture, providing a stable polymer blend. Typically, in a stable incompatible polymer blend, one of the incompatible polymers is dispersed as fibers throughout the mixture. This fiber-reinforced-polymer blend is a result of preparing the incompatible polymer blend using techniques as described in U.S. Pat. Nos. 4,716,201; 4,814,385 and 5,290,866, which are incorporated in their entirety by reference herein. To further enhance the property of the fiber-reinforced polymer blend, the treated filler can be added to one of the incompatible polymers prior to creating the stable incompatible polymer blend and the properties of the incompatible blend, such as stiffness and strength can be enhanced.

Further in accordance with the invention, a method is provided for fabricating a polymer article, the method including the steps of treating a filler through processes which exfoliate, delaminate or intercalate the filler, dispersing the treated filler into a polymer matrix and forming the polymer matrix into a polymer composite article. In accordance with a preferred embodiment of the invention, the filler is treated by an edge-treatment process.

In accordance with one aspect of the invention, the article of the invention is a polymer composite sheet. The treated-fillers can be incorporated into a polymer to form a filled polymer composite sheet through a number of processing methods, such as, for example, extrusion or other melt-processing techniques. In one embodiment, the polymer is melt-processed in a compounding extruder, preferably a twin screw extruder, before the treated-fillers are fed into the extruder through a side feeder. The melt-processing can be conducted with or without ultrasound assistance. The mixture of polymer and treated fillers is then melt-homogenized in the extruder, extruded through a strand-die into strands and cut into pellets. The pellets are then melt-processed in another extruder equipped with a sheet die to form sheets of desirable thickness. In another embodiment, the polymer and the treated fillers are melt-processed with a compounding extruder equipped with a sheet die, therefore, bypassing the pelletization step and extruding the composite directly into a sheet of desirable thickness.

Alternatively, the treated fillers can be added during the polymerization process instead of being added during the melt-processing method as described above. Preferably, the treated fillers are added to the reactor.

Alternatively, the treated filler can be dispersed in a solution or a solvent blending process. The polymer is dissolved in a solvent to form a solution, and the treated filler is added and mixed, so as to disperse the filler in the polymer matrix.

Further in accordance with the invention, if desired, the polymer composite sheets are formed into products by conventional plastic processing techniques. For example, and not limitation, the products can be fabricated from the polymer composite sheets by thermoforming, die-cutting, molding techniques and compression techniques. The polymer composite sheet, which can be single-layer or multi-layer construction, is formed into packaging and consumer products including but not limited to trays, containers, bags, bottles, sleeves, cups, plates, bowls, storage-ware, dinnerware, cookware and the like. In a preferred embodiment, the extruded composite sheet is then fed into a thermoformer, heated to a temperature suitable for thermoforming, and molded into products such as containers, dinnerware, cookware, trays, bowls, plates, cups and other consumer products.

In accordance with one aspect of the invention, the polymer composite sheet can be formed into several products as disclosed, for purpose of illustration and not limitation, in U.S. Pat. Nos. 5,565,163; 5,595,769; 5,685,453; 5,716,138; 5,851,070; 5,860,530; 5,947,321; 5,979,687; 5,984,130; 6,042,856; 6,257,401; 6,402,377; 6,561,374; and 6,644,494, the disclosures of which are incorporated in their entirety by reference herein.

In accordance with the invention, the physical properties of the products are enhanced through the use of treated fillers. It shall be understood that any product formed by a mineral filled polymer or a polymer alone can be formed with the use of a polymer composite material having treated fillers dispersed throughout the polymer.

Alternatively, and in accordance with another embodiment of the invention, the products can be fabricated directly from the composite mixture of polymer resin and treated filler, therefore bypassing the step of forming a composite sheet. Accordingly, when formed directly from the composite resin mixture, the products can be made from the previously described polymers by various molding, such as blow molding, compression molding, or injection molding, and extrusion techniques known in the art. The packaging and consumer products that can be formed by molding and extrusion techniques include, but are not limited to, trays, containers, bags, sleeves, bottles, cups, bowls, plates, storage-ware, dinnerware, cookware and the like.

Superior properties are accomplished at relatively lower filler loadings when compared to the loadings required for non-treated fillers due to the dispersion of the platelets and particulates in the polymer, and the creation of favorable interactions at the filler-polymer interface. The superior properties of the new composites are obtained at low inorganic loadings. The use of less filler content leads to significant advantages. Not only are the polymer properties such as stiffness, strength, impact and barrier properties enhanced, however, considerable weight and cost savings are also achieved. As such, selected properties of an article formed of such treated filler polymers which are enhanced include rigidity, stiffness, impact properties, barrier properties, heat resistance, thermal stability, dimensional stability, nucleation characteristics, clarity, and flame retardancy characteristics.

The use of treated fillers, such as, for example, edge-treated talc, imparts considerable enhancements to products formed from the polymer sheets. For example, containers fabricated from treated-filler polymer sheets are more rigid and of a lower weight then comparable containers made of non-treated fillers. Furthermore, the improved barrier properties imparted to the polymer sheets allow for its use in containers or trays which are used in extended-shelf-life applications, such as, for example perishable goods and meats.

Additionally, conventional polypropylene or polystyrene trays and containers which typically do not possess any barrier properties can now exhibit such barrier properties. The improved barrier properties of the composite sheets having treated fillers are demonstrated through measurements of relative permeability of liquids and gases through the polymer composite sheets that are formed.

Dramatic reductions in permeability are obtained at low treated filler concentrations compared to conventionally-filled polymers with much higher filler concentration. Without being bound by theory, the lower permeabilities are a result of much larger effective diffusion distances that occur because the large aspect ratio of the treated filler layers forces the solutes to follow more tortuous paths in the polymer matrix around the treated filler layers. Additionally, the lower concentration of treated filler effects the crystallite size and quantity, thereby effecting the barrier property. Such barriers may be selective or non-selective depending on whether or not the barrier acts to prevent a specific gas or gases from penetrating or permeating the barrier material or structure. Thus, a water vapor or moisture barrier characteristic can be imparted on the polymer using suitable treated fillers to prevent penetration or permeation by water vapor. Similarly, an oxygen barrier can be provided to prevent penetration by oxygen (for example, oxygen as contained in the atmosphere) and a flavor or aroma barrier can be provided to prevent penetration by complex organic molecules that impart flavor or aroma. These barriers can act to prevent penetration or permeation by vapors or gases by means of certain physical or chemical properties that the barrier materials or barrier structures possess.

The products of the present invention provide increased shelf storage life for contents, including beverages and food that are sensitive to the permeation of gases. Products, more preferably containers, of the present invention often display a gas transmission or permeability rate (oxygen, carbon dioxide, water vapor) of at least 10% lower (depending on treated filler concentration) than that of similar containers made from filler-free polymer, thus resulting in correspondingly longer product shelf life provided by the container.

The enhanced thermal stability of the polymer composite sheets and products fabricated therefrom is also attributable to the use of treated fillers. This enhanced thermal stability, and more specifically an increase of approximately 10-80° C. of heat distortion temperature, allows for greater applications of products, specifically containers and trays fabricated from the polymer composite sheet. For example, crystallized polyethyleneterepthalate (CPET) having treated fillers therein of micro and nano size will exhibit improved performance at high oven temperatures. Similarly, the use of trays in both microwave and conventional ovens will be more attainable and a broad range of polymers can be utilized for dual oven use. Additionally, the use of polymer composites with treated fillers in polystyrene applications will allow containers fabricated from such material to be used under heat lamps or in microwaves. Indeed, the temperature window for the majority of the polymeric containers of the present invention can be increased.

In further accordance with the invention, the nucleation characteristics and crystallinity and crystalline morphologies of the polymer composite sheets are enhanced. The treated fillers allow for an increase in nucleation sites and overall smaller crystals. The smaller and more dispersed spherulites enhance the clarity of the container while increasing its stiffness and toughness. Accordingly, clarified polymeric products, such as, for example, containers, cups, sleeves, and trays are fabricated from the polymer composite sheets of the present invention. In accordance with yet anther embodiment of the invention, through the use of treated fillers, polyethyleneterepthalate (PET) can be nucleated to form crystallized polyethyleneterepthalate (CPET). Without being bound by a particular theory, the crystalline morphology may be altered such that CPET nucleated with treated fillers has increased temperature resistance yet with minimal loss of impact property.

In further accordance with the invention, the polymer composite articles of the present invention having treated fillers impart improved flame retardant characteristics. Accordingly, polymer composites with treated fillers, such as, for example, crystallized polyethyleneterepthalate (CPET), polypropylene and polystyrene composites have enhanced fire retardant characteristics and can be effectively used for broader applications.

The contents of all patents and patent applications cited herein are hereby incorporated by reference in their entirety to more fully describe the state of the art to which the invention pertains.

It will be apparent to those skilled in the art that various modifications and variations can be made in the method and system of the present invention without departing from the spirit or scope of the invention. Thus, it is intended that the present invention includes modifications and variations that are within the scope of the appended claims and their equivalents.

1. A polymer composite sheet comprising:
a polymer capable of being formed into a shape; and
a treated filler having a median particle size of about 0.1 nm-10 μm,
wherein the treated filler is dispersed throughout the polymer.

2. The polymer composite sheet of claim 1, wherein the treated filler is treated by an edge-modifying technique.

3. The polymer composite sheet of claim 2, wherein the edge treated filler has a surfactant adsorbed onto the edges thereof.

4. The polymer composite sheet of claim 1, wherein the treated filler is exfoliated.

5. The polymer composite sheet of claim 1, wherein the treated filler is delaminated.

6. The polymer composite sheet of claim 1, wherein the treated filler is intercalated.

7. The polymer composite sheet of claim 1, wherein the treated filler is selected from the group consisting of calcium carbonate, wollastonite, silica and phyllosilicates.

8. The polymer composite sheet of claim 7, wherein the phyllosilicates are selected from the group consisting of mica, kaolinite, smectite clays and talc.

9. The polymer composite sheet of claim 1, wherein the polymer is selected from the group consisting of polypropylene, polyethylene, polystyrene, styrene butadiene copolymers, polyurethanes, polyesters, polycarbonate, polyacrylonitriles, polyamides, styrenic block copolymers, ethylene vinyl alcohol copolymers, ethylene vinyl acetate copolymers, polyesters grafted with maleic anhydride, polyvinylidene chloride, aliphatic polyketone, liquid crystalline polymers, ethylene methyl acrylate copolymer, ethylene-norbornene copolymers, polymethylpentene and ethylene acrylic acid copoloymer, mixtures and copolymers thereof.

10. The polymer composite sheet of claim 1, wherein the sheet has a multi-layer construction.

11. The polymer composite sheet of claim 10, wherein the treated filler is treated by an edge-modifying technique.

12. The polymer composite sheet of claim 10, wherein the sheet includes at least a first layer of polymer material and a second layer of polymer material.

13. The polymer composite sheet of claim 12, wherein the polymer of the first layer is different than the polymer of the second layer.

14. The polymer composite sheet of claim 12, wherein a structural material of the first layer is different than a structural material of the second layer.

15. The polymer composite sheet of claim 1, further including a non-treated filler dispersed throughout the polymer.

16. The polymer composite sheet of claim 1, wherein the sheet includes at least two polymers, wherein at least one polymer contains a treated filler.

17. The polymer composite sheet of claim 16, wherein the at least two polymers are incompatible.

18. A product produced at least in part from a polymer composite sheet, the polymer composite sheet including:
a polymer capable of being formed into a shape; and
a treated filler having a median particle size of about 0.1 nm-10 μm,
wherein the treated filler is dispersed throughout the polymer.

19. The product of claim 18, selected from the group consisting of trays, containers, bags, sleeves, bottles, cups, plates, bowls, storage ware, dinnerware and cookware.

20. The product of claim 18, wherein the treated filler is treated by an edge-modifying technique.

21. The product of claim 20, wherein the edge treated filler has a surfactant adsorbed onto the edges thereof.

22. The product of claim 18, wherein the treated filler is exfoliated.

23. The product of claim 18, wherein the treated filler is delaminated.

24. The product of claim 18, wherein the treated filler is intercalated.

25. The product of claim 18, wherein the treated filler is selected from the group consisting of calcium carbonate, wollastonite, silica and phyllosilicates.

26. The product of claim 25, wherein the phyllosilicates are selected from the group consisting of mica, kaolinite, smectite clays and talc.

27. The product of claim 18, wherein the polymer is selected from the group consisting of polypropylene, polyethylene, polystyrene, styrene butadiene copolymers, polyurethanes, polyesters, polycarbonate, polyacrylonitriles, polyamides, styrenic block copolymers, ethylene vinyl alcohol copolymers, ethylene vinyl acetate copolymers, polyesters grafted with maleic anhydride, polyvinylidene chloride, aliphatic polyketone, liquid crystalline polymers, ethylene methyl acrylate copolymer, ethylene-norbornene copolymers, polymethylpentene and ethylene acrylic acid copoloymer, mixtures and copolymers thereof.

28. The product of claim 18, wherein the sheet has a multi-layer construction.

29. The product of claim 28, wherein the treated filler is treated by an edge-modifying technique.

30. The product of claim 28, wherein the sheet includes at least a first layer of polymer material and a second layer of polymer material.

31. The product of claim 30, wherein the polymer of the first layer is different than the polymer of the second layer.

32. The product of claim 30, wherein a structural material of the first layer is different than a structural material of the second layer.

33. The product of claim 18, wherein the polymer composite sheet further includes a non-treated filler dispersed throughout the polymer.

34. The product of claim 18, wherein the sheet includes at least two polymers, wherein at least one polymer contains a treated filler.

35. The product of claim 34, wherein the at least two polymers are incompatible.

36. A method for fabricating a polymer composite article, the method comprising:
treating a filler to create a treated filler, wherein the treated filler is intercalated, exfoliated or delaminated;
dispersing the treated filler into a polymer matrix; and
forming the polymer matrix into a polymer composite sheet.

37. The method of claim 36, wherein the filler is treated by an edge-treatment process.

38. The method of claim 36, wherein the polymer matrix is formed into a polymer composite article through a melt-processing technique selected from the group consisting of extrusion, compression molding, blow molding, injection molding or injection blow molding.

39. The method of claim 36, wherein the treated filler is dispersed in the polymerization process.

40. The method of claim 36, wherein the treated filler is dispersed in a solution or a solvent blending process.

41. The method of claim 36, further comprising the step of forming the polymer composite sheet into a product.

42. The method of claim 41, wherein the product is selected from the group consisting of trays, containers, bags, sleeves, bottles, cups, plates, bowls, storage ware, dinnerware and cookware.
